(19) United States
(12) Patent Application Publication
(10) Pub. No.: US 2012/0207883 A1
(43) Pub. Date: Aug. 16, 2012

(54) ALKALINE BOOSTER WITH ANTIOXIDANTS

(76) Inventor: Robert Kim, Alpine, NJ (US)

(21) Appl. No.: 13/024,565

(22) Filed: Feb. 10, 2011

(51) Int. Cl. A23L 1/304; A23L 1/305; A23L 1/302; A23L 1/29

(52) U.S. Cl. 426/72; 426/648; 426/74; 426/665

(57) ABSTRACT

A highly alkaline, ultra-low sodium solution of saturated tripotassium phosphate may be used as an additive to dosages such as concentrated drops, tablets, capsules, bottled water, beverages or other dosage forms. The additive further includes organic potassium, calcium, zinc, magnesium, selenium and 79 trace minerals from ancient sea salt. The trace minerals are taken from the low-sodium technical magnesium chloride marine deposits and chelated with amino acids. The amino acids are from a non-animal source which is suitable for vegetarian and persons who are allergic to animal proteins. The additive, which is considered nutritionally nil in sodium content, can be used as a concentrated aqueous drop or dried and used as an additive for dietary supplement dosage forms including tablets, capsules, bottled water, beverages and others.

### BACKGROUND OF THE INVENTION

1. Field of the Invention

The present invention relates to improving human health, and more particularly to a source of alkaline (high pH) additive for dietary supplements, concentrated drops, tablets, capsules, bottle water, and beverages and related dietary supplement dosage forms.

2. Description of Related Art

For nearly a century alkaline water and electrolyte supplementation have been known to have certain health benefits. The scientific literature for electrolyte replacement and acid-base balance is voluminous, including Schwartz and Lyons, “Acid-Base and Electrolyte Balance—Normal Regulation and Clinical Disorders”, Grune & Stratton (1977); Carrol and Oh, “Water, Electrolyte and Acid—Base Metabolism”, Lippincott (1978); Kokko and Tannen, “Fluids and Electrolytes”, 2^{nd} Ed, WB Saunders Co. (1990), and others.

In addition to the mainstream scientific research support of alkaline and electrolyte supplementation, the alternative medicine community advocates the supplementation of drinking water with alkaline additives. This includes Sang Whang's seminal book “Reverse Aging”, Jsp Publishing (1991); Dr. Ted Baroody's “Alkalize or Die”, Holographic Health Inc, 8^{th} ed. (1991); Dr. F. Batmanghelidj's “Your Body's Many Cries for Water”, Global Health Solutions; 2^{nd} ed. (1995); and Herman Aihara's “Acid and Alkaline” George Ohsawa Macrobiotic Foundation; 5^{th} ed. (1986).

The commercial value of alkaline water and electrolyte supplementation has significantly risen in recent years. These take the forms of water ionizer machines, such as Enagic (Los Angeles, Calif.) and Chanson (Laguna Hills, Calif.). These machines separate the normal drinking water into an acidic portion which is disposed of or for other use and an alkaline portion which is consumed for better health. These machines are bulky, require electric power source, and are relatively expensive. Further examples of the commercial value are demonstrated by patents and commercial products of alkaline electrolyte supplement water and beverages as well as tablets, capsules, and teas.

The U.S. Pat. No. 3,215,626 to Console describes a method of producing mineralized drinking water by adding potassium tri polyphosphate.

The U.S. Pat. No. 5,306,511 to Whang pertains to a concentrated additive solution that is added to normal drinking water to form an alkaline drinking water. Such water is of increased oxygen content with pH said to be in the range of 9 to 12. The concentrated additive solution is a combination of potassium hydroxide (KOH) and sodium hydroxide (NaOH).

The U.S. Pat. No. 5,849,346 to Hornack discloses a concentrated hydroxide solution, which is added to the acidic beverages such as coffee, tea, wine and other alcoholic beverages. The desired pH of beverages after addition of the concentrated hydroxide solution is about 7 to 11, preferably about 10 to 10.5.

The U.S. Pat. No. 6,572,902 to Abramowitz et al. discloses a process for producing alkaline drinking water and the product produced thereby. The alkaline water has a pH within the range of 9-10.

The U.S. Pat. No. 7,090,878 to Mehansho et al. discloses a water composition that is fortified with minerals and has a pH between about 2.5 and 9.5.

The U.S. Pat. No. 7,785,642 to Kaehne discloses mineral water compositions made of four different groups of elements. The pH is preferably adjusted to a final value of between 6.6 to 8.0 with a still water or a final value of between 2.5 to 8.0 for an aerated or carbonated water.

Having understood the mainstream scientific research interest, the alternative medicine interest, and the commercial interest, and the attempts to meet these needs, it was found that the existing practices and technologies still encounter challenges.

1. A central theme in the alternative medicine is the eating of alkaline vegetables and drinking of alkaline beverages. However, the so called alkaline vegetables are only pH 6 (mildly acidic) so that they are not really alkaline vegetables. The chance to drink naturally occurring alkaline water is very slim because these natural lye, high pH (alkaline) springs are scarce and hard to find. No nationwide firm is supplying this need.
2. The machines that produce high pH water are expensive for persons who live on a fixed income. Moreover, these bulky machines are impossible to carry by those who must travel.
3. Hydroxide drops as suggested in the U.S. Pat. No. 5,306,511 to Whang, and U.S. Pat. No. 5,849,346 to Hornack are dangerous to skin, and eyes. Many people are afraid to use a lye based (sodium/potassium hydroxide) product orally in human electrolyte replacement. Besides, sodium/potassium hydroxide has no buffer capacity for strong acids such as gastric acid.
4. Alkaline teas and tea bags are expensive to use regularly and are not readily available on a nationwide basis.
5. There are no nationally distributed products combining alkaline electrolytes added to regular vitamin-botanical dietary supplement.
6. Most of the examples in the aforementioned patents or commercial products still contain sodium which is not recommended by nutritionists, especially for persons with cardiovascular problems.

Unlike some of the above-mentioned art such as the U.S. Pat. No. 7,090,878 to Mehansho et al., the U.S. Pat. No. 7,785,642 to Kaehne, the U.S. Pat. No. 6,572,902 to Abramowitz et al, and the U.S. Pat. No. 3,215,626 to Console, wherein the products are ready to drink water or beverages or powder in a pouch attached to ready to drink bottled water, the invention described and claimed in the present application relates to an additive that is enriched with trace minerals from ancient sea salt and alkaline electrolytes, and produces a final pH above 9 after it is added to water or beverages. The invention in the form of an additive, rather than in a form of bulky ready to drink water or beverages, is convenient to carry so that the users can intake alkaline electrolytes and minerals any place any time. Moreover, the present invention is distinct from other patents in that the present invention produces a final pH above 9 and contains amino acids to chelate with trace minerals from the ancient sea salt.

### SUMMARY OF THE INVENTION

An object of the invention is a low sodium additive for alkaline dietary supplement dosages that is mild in terms of acute and sub-acute skin and eye toxicity, yet still capable of producing beverages with a final pH above 9.

Yet another object is such an additive that is inexpensive, available in liquid form and dry dosage form, easy to pack and travel with and requires no power source.

Still another object is such an additive that offers up to 79 additional trace minerals including zinc and selenium.

A further object is such an additive that offers non-animal sourced amino acids or protein hydrolysate to chelate trace minerals.

A further object is such an additive that does not contain any preservatives.

The foregoing and other objects, features, and advantages of the present invention are accomplished in accordance with the teachings of the present invention. One illustrative embodiment of which comprises a highly alkaline, ultra-low sodium solution of organic potassium salts and saturated tripotassium phosphate that may be used as an additive to dosages such as concentrated drops, tablets, capsules, bottle water, beverages or other dosage forms.

As previously discussed, an objective of the invention is to provide an additive that is capable of producing beverages with a pH above 9. It is known that tripotassium phosphate or trisodium phosphate has better buffer capacity above pH 9 than sodium hydroxide or potassium hydroxide. Besides, phosphorous is found in all cells and is involved in most biochemical reactions. It plays an important role in protein synthesis for the growth, maintenance, and repair of all tissues and cells. Because high amount of sodium is harmful to the human body especially to the cardiovascular system, tripotassium phosphate is selected as the major component in the prevent invention. Potassium is also an essential dietary mineral and electrolyte. Normal body function depends on tight regulation of potassium concentrations both inside and outside of cells. Potassium can stimulate kidney's function and stabilize heart rhythms. Moreover, tripotassium phosphate is mild in terms of acute and sub-acute skin and eye toxicity.

The additives further include calcium, zinc, magnesium, and selenium and up to 79 trace minerals from ancient sea salt, especially from the technical magnesium chloride marine deposits that are low in sodium. It's known that the absorption and bioavailability of certain minerals or electrolytes by human body may be low. It's also known in the art that the bioavailability of certain minerals or electrolytes can be increased if administered in the form of chelates wherein the chelating ligands are amino acids. One solution to deliver such an additive that offers bioavailable minerals and alkaline electrolytes is disclosed in PCT publication WO 99/21437 to Better Health Lab. Inc., published on May 6, 1999, which uses amino acids derived from a non-porcine source (fish gelatin) to chelate with minerals. Instead of using fish gelatin, the invention described and claimed in the present application utilizes amino acids from a non-animal source (papain); thus, the present invention is suitable for vegetarians or persons who are allergic to fish gelatin. Papain is an enzyme, also known as papaya proteinase I, which is present in unripe papayas. It is used in cooking as a meat tenderizer; it can break down the tough meat fibers. In the present invention, it serves as the source of amino acids; once it is heated in acidic condition (citric acid in the formula), it decomposes to free amino acids, which can chelate with trace minerals.

Another improvement over the invention published in WO 99/21437 is that the present invention does not contain any preservative. Most bacteria require an isotonic environment or a hypotonic environment for optimum growth. Very few organisms can grow at relatively high salt concentration (up to 10%). Moreover, very few organisms can grow at high alkaline (up to pH 10) environment. Considering the formula disclosed in the present invention which has high salt concentration (about 30%) and high pH (above pH 11), the organisms are less likely to grow; thus, the present invention does not need to contain any preservative.

Yet another improvement over the invention published in WO 99/21437 is that the selenium as a critical trace mineral is added to the formula disclosed in the present application. Human require selenium for the function of a number of selenium-dependent enzymes, also known as selenoproteins. Selenium is an antioxidant that protects cell membranes and intra-cellular structural membranes from lipid peroxidation. Selenium deficiency has been associated with muscular weakness, impaired function of the immune system and others.

The present invention which is considered nutritionally nil in sodium content, can be used as a concentrated aqueous drop, or dried and used as an additive for dietary supplement dosage forms including tablets, capsules, bottled water, beverages and others.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### DESCRIPTION OF THE PREFERRED EMBODIMENT

The purpose of the invention is to provide low sodium, safe additive (which may have pH of above 11) to a dietary supplement dosage form to effect an increase in the pH to about 8-10, preferably 9. The beverage or product thus created or modified are not intended to treat or cure any disease. They do, however, neutralize acids and they do enable the user or patient to achieve an alkaline lifestyle plus receiving benefits from electrolytes and minerals.

Initially purified water is charged into a previously sanitized stainless steel steam jacketed vessel equipped with a propeller mixer. Alternatively, the purified water may be heated to 80-90 degrees Celsius via a heat exchange unit.

Citric acid and a trace mineral (special marine sea salt) concentrate is introduced along with a high proteolytic activity papain enzyme.

As this mixture is slowly cooled, the hot papain enzyme is cleaved in the hot acidic environment and decomposed to free amino acids, which can chelate the trace minerals.

Slow mixing with slow cooling is continued until the mixture reaches about 50 degrees Celsius.

At this point an electrolyte mass up of saturated tripotassium phosphate is added and then organic potassium salts including potassium bicarbonate, potassium citrate, and potassium lactate 60% are added, small amounts of magnesium chloride, zinc lactate, calcium chloride and selenium are also added.

The slurry resulting therefrom is somewhat opaque and may require setting before final filtration. The product is cooled without mixing for 24 hours for complete coagulation of the non-soluble portions.

In the next operation the product is decanted, run through a fine filter (range of microns preferably 10-175) cartridge and packaged, or processed further.

The product is now a clear liquid and can be dispensed as a clear drop in a small dropper assembly, operating closure, droplet cap or preferably “drop-trainer”. When processed further it can be dried on a drum drier and added to the formulation of conventional vitamin-mineral-botanical dosage forms including tablets, capsules, bottled water, beverages and the like.

The invention is further characterized by the tripotassium phosphate being in the 10-50% range of the total weight of the product, the organic potassium being in the 0.1-3% range, the minerals being in the 1-40 ppm range, the amino acids being in the 2-500 ppm range, the citric acids being in the 0.01-0.25% range and the papain enzymes being in the 2-500 ppm.

The above procedure is the most preferred embodiment of the invention. Moderate ranges occur around these percentages and procedures and are included in this patent.

The ranges above are the embodiment of the patent. The preferred range are about: 15-35% of tripotassium phosphate, 0.03-3% organic potassium salts, 3-25 ppm of trace minerals, 0.03-18% citric acid and 5-250 ppm high proteolytic papain enzyme. The preferred filtering range would be using a 20-125 micron cartridge.

The most preferred embodiment of the patent would be about 30% of the tripotassium phosphate, 0.05-2% organic potassium salts, 5-15 ppm trace minerals, 0.05-10% citric acid, 20-40 ppm high proteolytic enzyme. The most preferred filtration cartridge is 10-20 micron.

The most preferred ingredient ranges is a balance of efficacy, taste consideration, economical considerations, and production ease considerations.

In all cases the dosage form will effect an increased alkalinity in the human system. For example, when two drops of this low sodium additive drop (or one unit of the tablet, capsule, tea bag, etc.) is used in or with a single 8-10 ounce beverage, the resultant pH will be approximately 8-10, preferably 9.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

### EXAMPLE

One suitable example of the invention in liquid form for human consumption, which is by no means exclusive, is as a follows:

| Ingredient | % by weight |
|---|---|
| High proteolytic papain enzyme | 0.001 |
| Citric acid | 0.20 |
| Tech. magnesium chloride (marine source) | 0.10 |
| Tripotassium phosphate | 30 |
| Magnesium chloride | 0.03 |
| Selenium (Selenite) | 0.03 |
| Potassium bicarbonate | 6.00 |
| Zinc lactate | 0.05 |
| Potassium citrate | 0.10 |
| Calcium chloride | 0.05 |
| Potassium lactate 60% | 2.00 |
| Purified deionized water | qs |

Although this invention has been described in terms of a preferred embodiment, various changes and modifications can be made without departing from the spirit and scope of the invention.

What is claimed is:

1. A low sodium additive for alkaline dietary supplement dosages comprises saturated tripotassium phosphate, with the concentration of tripotassium phosphate being from about 10-50 percent by weight.

2. The additive of claim 1, wherein the tripotassium phosphate being preferably about 30% by weight.

3. The additive of claim 1 further comprises trace amount of calcium.

4. The additive of claim 1 further comprises trace amount of magnesium.

5. The additive of claim 1 further comprises trace amount of zinc.

6. The additive of claim 1 further comprises trace amount of selenium.

7. The additive of claim 1 further includes 79 trace minerals from sea.

8. The additive of claim 7, wherein the trace minerals are selected from low sodium technical magnesium chloride marine deposits.

9. The additive of claim 8 further comprises amino acids from non-animal sources.

10. The additive of claim 9, wherein the trace minerals are chelated with free amino acids.

11. A low sodium additive for alkaline dietary supplement dosages comprises tripotassium phosphate, with the concentration of tripotassium phosphate being from about 10-50 percent by weight, organic potassium salts, trace minerals, citric acid, amino acids, and trace amount of magnesium, zinc, selenium, calcium; the trace minerals are chelated with amino acids.

12. The additive of claim 11, wherein the amino acids are derived from non-animal peptides or proteins.

13. The additive of claim 11, wherein the trace minerals are selected from low sodium technical magnesium chloride marine deposits.

14. The additive of claim 11, wherein the preferred range are about 15-35% tripotassium phosphate, 0.03-3% organic potassium salts, 3-35 ppm trace minerals, 0.03-18% citric acid, 5-250 ppm of amino acids derived from 5-250 ppm high proteolytic enzyme, and trace amount of magnesium, zinc, selenium, calcium; all the units are weight by weight.

15. The additive of claim 11, wherein the preferred range are about 30% of tripotassium phosphate, 0.05-2% organic potassium salts, 5-15 ppm trace minerals, 0.05-10% citric acid, 20-40 ppm of amino acids derived from 20-40 ppm high proteolytic enzyme, and trace amount of magnesium, zinc, selenium, calcium; all the units are weight by weight.

16. A method for producing the low sodium additive for alkaline dietary supplement dosages comprising tripotassium phosphate, with the concentration of tripotassium phosphate being from about 10-50 percent by weight.

17. The additive of claim 11 may be packaged in a small dropper assembly, operating closure, droplet cap or preferably “drop-trainer”.

18. The additive of claim 11 may be further dried and added to the formulation of conventional vitamin-mineral-botanical dosage forms including tablets, capsules, bottled water, beverages and the like.
